(19) United States
(12) Patent Application Publication
(10) Pub. No.: US 2006/0167631 A1
(43) Pub. Date: Jul. 27, 2006

(54) Device and method for definition of navigation directions by a user on user interface screen

(75) Inventor: Eui-Suk Chung, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/338,047

(22) Filed: Jan. 24, 2006

(30) Foreign Application Priority Data
Jan. 26, 2005 (KR) 2005-7313

(51) Int. Cl. G01C 21/32

(52) U.S. Cl. 701/211; 340/995.1

(57) ABSTRACT

A device and a method for definition and display of navigation directions by a user on a user interface screen is provided. The device includes a memory for storing a direction key mapping table; at least one direction key for indicating a predetermined direction; and a control unit for flickering a user interface element which is displayed on a screen and is currently in active state, if initial key input for a predetermined direction key is determined to have lasted for more than a predetermined time period, for stopping flickering of the current element and finding and flickering an element closest to the current element in the direction of a predetermined direction key, if key input for at least one direction key is determined to be performed, and for mapping the flickering element to the initially input direction key and storing the flickering element in the memory, if key input for a direction key is determined to have lasted for more than a predetermined time period.

### PRIORITY

This application claims priority to an application entitled “Device And Method For Definition of Navigation Directions By A User On User Interface Screen” filed with the Korean Intellectual Property Office on Jan. 26, 2005 and assigned Serial No. 2005-7313, the contents of which are incorporated herein by reference.

### BACKGROUND OF THE INVENTION

1. Field of the Invention

The present invention relates to a device and a method for controlling operations of direction keys in a user interface unit, and more particularly to a device and method for definition and display of navigation directions by a user on a user interface screen.

2. Description of the Related Art

An example of a device having a user interface unit in which a touch screen is installed under a screen so that a user can draw pictures, write letters, and perform input by touching a menu displayed in the screen, using a stylus pen, is a PDA (Personal Digital Assistant).

Recently, a PDA function has been incorporated into a portable phone function to form a so-called complex terminal. The complex terminal has direction keys indicating four directions (up, down, right, and left) and a confirmation key (OK) so that a user can use the terminal with one hand, in order to provide a one-handed operation/navigation function in which all items on the screen can be controlled using the keys with only one hand.

However, according to a current product implementing the one-handed operation function, the next navigation is easily conjectured in the case of pressing the up, down, right, and left direction keys in an application of simple structure, but occasionally cannot be so in an application of complex structure. In that case, a user can see which navigation is selected only by actually pressing the keys. It causes inconvenience for a user and, worst of all, can cause malfunctions.

FIGS. 1 to 4 show user interface screens of a conventional PDA, in which the position of an active object can be changed in a direction different from a direction intuitionally conjectured by a user, if a one-handed operation/navigation function is used with the user's conjecture and experience.

According to the figures, which user interface element should be selected is unclear in the case in which a user presses a predetermined direction key on the basis of a currently selected user interface element, which is an active object, i.e., a highlighted icon (or menu item, hereinafter referred to as icon). It is because only the icon “Sprite Backup” is highlighted, so only the currently selected user interface element (active object) can be seen clearly and there is no visual display or explanation on navigation according to key inputs for the direction keys, as seen in FIG. 1.

Similarly, in the screen state of FIGS. 2 and 3, if the one-handed operation/navigation function is used only by a simple intuition of a user, the possibility of operation errors are high.

In another example, referring to FIG. 4, a user conjectures to select a item around the object (Samsung TV) which seems to be an active object on the current screen, when the user uses the up, down, right, or left direction key. However, the level of PDA volume is actually regulated, which seems to be irrelevant to the direction key.

### SUMMARY OF THE INVENTION

Accordingly, the present invention has been made to solve the afore-mentioned problems occurring in the prior art, and an object of the present invention is to provide a device in which a user can conveniently determine navigation directions by displaying not only a user interface element currently selected on a screen but also which element is mapped to at least one direction key on the basis of the currently selected element.

It is another object to provide a device and a method in which a user can arbitrarily set an element mapped to at least one direction key, on the basis of the user interface element currently selected on a screen.

In order to accomplish these objects, according to the present invention, there is provided a device for displaying navigation directions in an apparatus in which user interface is performed through a touch screen. The device includes at least one direction key indicating a predetermined direction; at least one indicator for representing that at least one of user interface elements displayed on a screen is the next active object, if key input is performed for a corresponding direction key; and a control unit for displaying the indicator in response to the input of the direction key.

According to the present invention, there is also provided a device for definition of navigation directions by a user in an apparatus in which user interface is performed through a touch screen. The device includes a memory for storing a direction key mapping table; at least one direction key for indicating a predetermined direction; and a control unit for flickering a user interface element which is displayed on a screen and is currently in active state, if initial key input for a predetermined direction key is determined to have lasted for more than a predetermined time period, for stopping flickering of the current element and finding and flickering an element closest to the current element in the direction of a direction key, if key input for at least one direction key is determined to be performed, and for mapping the flickering element to the predetermined initially input direction key and storing the flickering element in the memory, if key input for a direction key is determined to have lasted for more than a predetermined time period.

According to the present invention, there is further provided a method for definition of navigation directions by a user in an apparatus in which user interface is performed through a touch screen. The method includes checking whether initial key input for a predetermined direction key has lasted for more than a predetermined time period, in a state in which user interface elements are displayed in a screen; checking whether key input has been performed for a direction key, if the key input for the predetermined direction key is determined to have lasted for more than the predetermined time period; finding an element closest to the current element in the direction corresponding to the direction key, if the key input for the direction key is determined to have been performed; checking whether key input for a direction key has lasted for more than a predetermined time period, after finding the closest element; mapping the element found most recently, to the predetermined initially input direction key and registering the element, if the key input for the direction key is determined to have lasted for more than the predetermined time period; and returning to the finding step, if, after checking whether key input for a direction key has been performed, the key input for the direction key is determined to have been performed, after finding the closest element.

### BRIEF DESCRIPTION OF THE DRAWINGS

The above and other objects, features, and advantages of the present invention will be more apparent from the following detailed description taken in conjunction with the accompanying drawings, in which:

FIGS. 1 to 4 show user interface screens of a conventional PDA;

FIGS. 5 to 7 show user interface screens of a PDA according to a preferred embodiment of the present invention;

FIG. 8 is a block diagram of the constitution of a user interface device according to of the present invention;

FIG. 9 is a flow chart representing a method for displaying a user interface screen of the user interface device according to the present invention; and

FIG. 10 is a flow chart representing a method in which navigation directions of a user interface device are defined by a user according to the present invention.

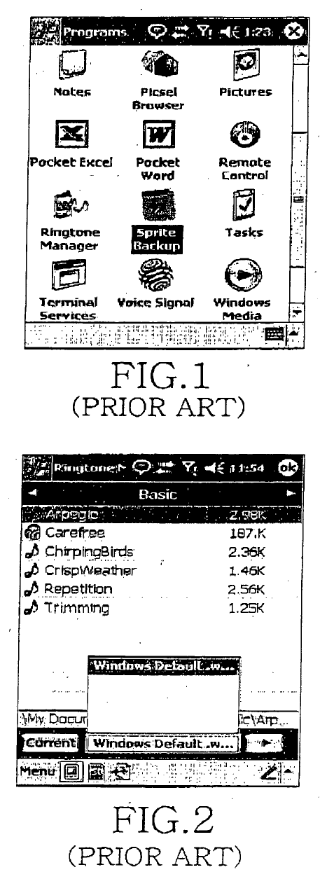

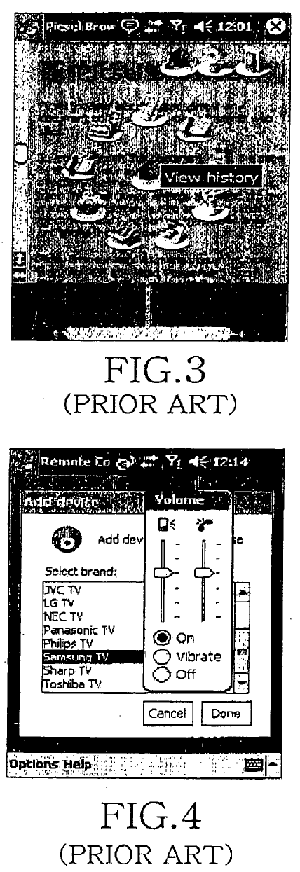

### DETAILED DESCRIPTION OF THE PREFERRED EMBODIMENT

Hereinafter, preferred embodiments of the present invention will be described with reference to the accompanying drawings. In the following description of the present invention, details such as concrete menu items and titles of icons are represented, but they are provided only to help overall understanding of the present invention and it is apparent to those skilled in the art that the present invention can be performed without these details. Further, in the following description of the present invention, a detailed description of known functions and configurations incorporated herein is omitted to avoid making the subject matter of the present invention unclear.

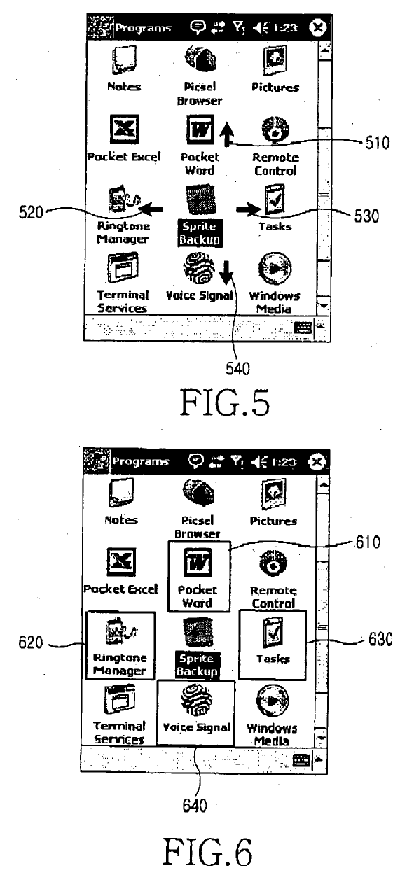

FIGS. 5 to 7 show user interface screens of a PDA according to the present invention.

Referring to FIG. 5, a user is visually informed of how the up, down, right, and left direction keys are mapped using arrow-shaped indicators representing four directions. Namely, the four arrow-shaped indicators 510 to 540 are displayed with respect to an icon “Sprite Backup” which is currently in an active state. For example, the up direction arrow 510 is separated from an icon “Pocket World” by a predetermined distance on a side of the icon “Pocket world”, which is on the upside of the icon “Sprite Backup”. This tells that, when the current icon “Sprite Backup” is in an active state, i.e. the highlight is in the icon “Sprite Backup”, if a user presses the up direction key, the icon “Pocket World” falls into an active state. In other words, this shows in advance that the highlight will move to the icon “Pocket World”.

Referring to FIG. 6, it will be understood that color boxes 610 to 640 can take the place of the arrow-shaped indicators of FIG. 5.

There is also a method which does not use such separate indicators as shown in FIGS. 5 and 6. Namely, although not shown, when the direction keys are pressed on the basis of an icon currently in an active state, the icons which are to be in the active state are displayed differently from the icons of normal brightness, in order to discern them, such as displaying them fainter, or bolder, than the other icons.

The display methods are only concrete examples of a method for displaying mapping of the up, down, right, and left direction keys, and a PDA is only an application example. The point of the present invention is that the present invention can provide convenience by visually showing navigation operation according to inputs of direction keys on a user interface screen.

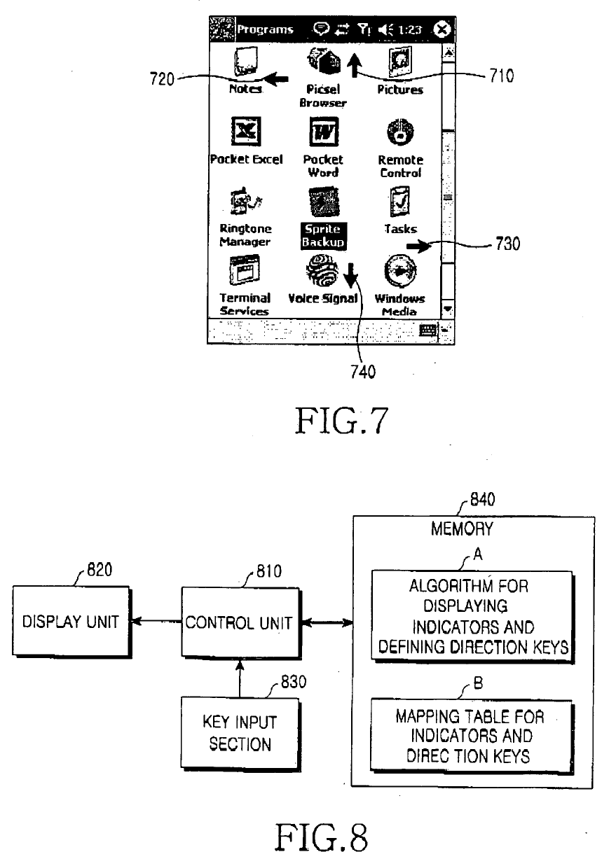

Referring to FIG. 7, the icons, which will be active objects, can be arbitrarily determined by pressing direction keys on the basis of the icon which is currently in the active state. This can be understood by the indicators 520 (FIG. 5) and 720, which are displayed on a side of the icons mapped to the left direction key. In other words, an icon mapped to the left direction key on the basis of the icon “Sprite Backup”, which is currently in the active state, can be not only “Ringtone Manager” as shown in FIG. 5 but also “Notes” as shown in FIG. 7.

FIG. 8 is a block diagram of the constitution of a user interface device according to the present invention.

A display unit 820 displays a user interface screen. A touch screen is installed under the screen so that a user can select the icons displayed on the screen using a stylus pen. A key input section 830 includes the up, down, right, and left direction keys for one-handed operation/navigation and a confirmation key OK, and key inputs are transferred to a control unit 810 which controls the display unit 820 to display both a user interface element, which is currently selected on the screen, and elements mapped to the up, down, right, and left direction keys on the basis of the currently selected element. Further, the control unit 810 controls the elements mapped to the up, down, right, and left direction keys on the basis of the currently selected user interface element to be arbitrarily set by a user. A memory 840 includes a region A storing algorithms for displaying the indicators and defining the direction keys and a region B storing a mapping table of the indicators and the direction keys. The regions A and B may also be provided in separate memories. In the mapping table of the indicators and the direction keys, the form of the indicators, i.e., whether the indicators are arrows or boxes as shown in FIGS. 5 and 6 as examples, and the positions of the indicators can be stored, and the information on the direction key mapping elements defined by a user also can be stored.

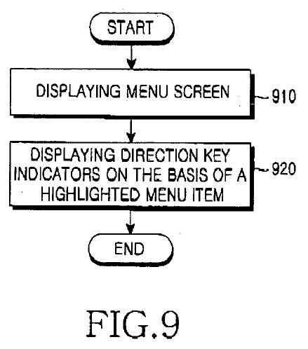

FIG. 9 is a flow chart represent a method for displaying a user interface screen of the user interface device according to the present invention.

The control unit 810 displays a user interface screen in the display unit 820 in Step 910. If the display operation is performed by menu key inputs of a user, an initial user interface screen, which is preset so as to be displayed when key input is performed for the menu key, will be displayed and in which items the highlight will be positioned will be determined in advance.

Therefore, the control unit 810 displays at least one direction key indicator on the basis of the highlighted menu item in Step 920. Then, the indicator mapping table of the memory 840 may be referred to for the form of the displayed indicators.

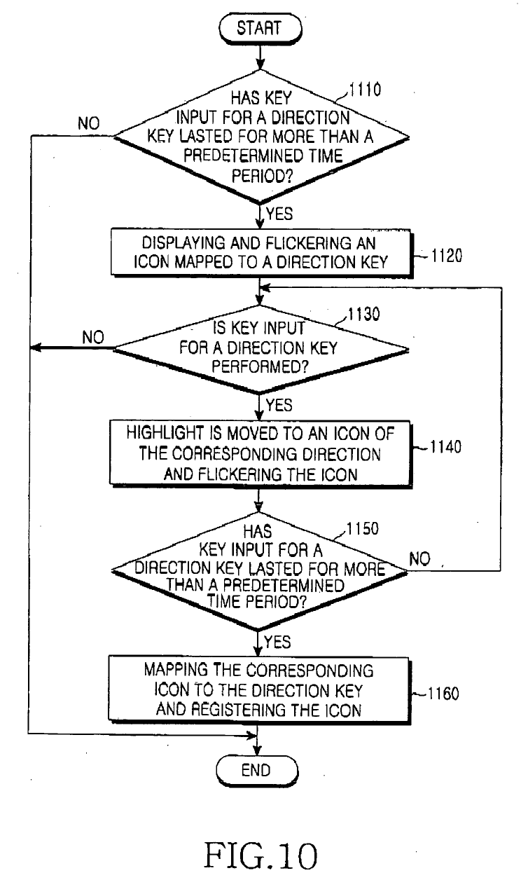

FIG. 10 is a flow chart represent a method in which navigation directions of a user interface device are defined by a user according to the present invention.

It is assumed that the direction key indicators are displayed on the user interface screen through the process shown in FIG. 9. The control unit 810 checks whether key input for a direction key has lasted for more than a predetermined time period in Step 1110. Then, if the key input for the direction key is determined to have lasted for more than the predetermined time period, the control unit 810 flickers the icon mapped to the direction key in Step 1120. Further, the control unit 810 checks whether key input for the same or a different direction key is performed in Step 1130. At this time, the control unit 810 does not check for a long input but instead checks for a short input. If a short input for the direction key is detected, the control unit 810 moves the highlight to the icon in the direction corresponding to the direction key and flickers the icon in Step 1140. Thereafter, the control unit 810 checks whether key input for a direction key has lasted for more than a predetermined time period in Step 1150. Then, if the key input for the direction key is determined to have lasted for more than the predetermined time period, the control unit 810 maps the icon, which has been flickered in 1140, to the direction key, which is input in Step 1130, and registers the icon in the direction key mapping table of the memory 840 in Step 1160.

On the other hand, if the key input for a direction key has not lasted for more than a predetermined time period in Step 1150, the control unit 810 proceeds with Step 1130 in which the control unit 810 checks whether the key input for the direction key is performed in a short input. The process can be performed several times for a user to find a wanted icon by repeating key inputs after flickering in Step 1120. Therefore, for an icon far away from the currently flickered icon, the feedback from Step 1150 to Step 1130 will be repeated several times. Referring to FIG. 7, if the currently flickering icon is assumed to be “Sprite Backup”, two key inputs for the up direction key is required to map the icon “Picsel Browser”, whose reference numeral is 710, to the direction key for upward navigation in the icon “Sprite Backup”. For another example, in order to map the icon “Notes”, whose reference numeral is 720, to the direction key for left navigation in the icon “Sprite Backup”, one key input for the left direction key after two key inputs for the up direction key or two key inputs for the up direction key after one key input for the left direction key are required.

As mentioned above, since the present invention visually shows where the active object is moved when a user presses the up, down, right, and left direction keys, a user of a one-handed operation/navigation function can easily grasp the next navigation even on a complex screen, thereby avoiding operation errors.

While the invention has been shown and described with reference to preferred embodiments thereof, it will be understood by those skilled in the art that various changes in form and details may be made therein without departing from the spirit and scope of the invention as defined by the appended claims.

What is claimed is:

1. A device for displaying navigation directions in an apparatus in which user interface is performed through a touch screen, the device comprising:
at least one direction key indicating a predetermined direction;
at least one indicator for representing that at least one user interface elements displayed on a screen is a next active object, if key input is performed for a corresponding direction key; and
a control unit for displaying the indicator in response to the input of the direction key.

2. A device according to claim 1, wherein the indicator is displayed in the form of a color box surrounding the element.

3. A device according to claim 1, wherein the indicator is separated from the element by a predetermined distance.

4. A device according to claim 3, wherein the indicator is displayed in the form of an arrow facing a predetermined direction.

5. A device according to claim 1, wherein the indicator is displayed by making brightness of the element faint in comparison to other elements.

6. A device according to claim 1, wherein the device includes direction keys indicating up, down, right, and left, and four indicators representing elements mapped to the direction keys.

7. A device for definition of navigation directions by a user in an apparatus in which user interface is performed through a touch screen, the device comprising:
a memory for storing a direction key mapping table;
at least one direction key for indicating a predetermined direction; and
a control unit for flickering a user interface element which is displayed on a screen and is currently in an active state, if initial key input for a predetermined direction key is determined to have lasted for more than a predetermined time period, for stopping flickering of the current element and finding and flickering an element closest to the current element in the direction of a direction key, if key input for at least one direction key is determined to be performed, and for mapping the flickering element to the predetermined initially input direction key and storing the flickering element in the memory, if key input for a direction key is determined to have lasted for more than the predetermined time period.

8. A device according to claim 7, further comprising at least one indicator for representing that at least one of the user interface elements displayed on the screen is a next active object, wherein the control unit controls the indicator to be displayed, based on the direction key mapping table, if key input is performed for a direction key.

9. A device according to claim 8, wherein the indicator is displayed in the form of a color box surrounding the element.

10. A device according to claim 8, wherein the indicator is separated from the element by a predetermined distance.

11. A device according to claim 10, wherein the indicator is displayed in the form of an arrow facing a predetermined direction.

12. A device according to claim 8, wherein the indicator is displayed by making brightness of the element faint in comparison to other elements.

13. A device according to claim 8, wherein the device includes direction keys indicating up, down, right, and left, and four indicators representing elements mapped to the direction keys.

14. A method for definition of navigation directions by a user in an apparatus in which user interface is performed through a touch screen, the method comprising the steps of:
checking whether initial key input for a predetermined direction key has lasted for more than a predetermined time period, in a state in which user interface elements are displayed on a screen;
checking whether key input has been performed for a direction key, if the key input for the predetermined direction key is determined to have lasted for more than the predetermined time period;
finding an element closest to a current element in a direction corresponding to the direction key, if the key input for the direction key is determined to have been performed;
checking whether key input for the direction key has lasted for more than a predetermined time period, after finding a closest element;
mapping the element found most recently, to the predetermined initially input direction key and registering the element, if the key input for the direction key is determined to have lasted for more than the predetermined time period; and
returning to the finding step, if, after checking whether key input for a direction key has been performed, the key input for the direction key is determined to have been performed, after finding the closest element.

15. A method for definition of navigation directions by a user in an apparatus in which user interface is performed through a touch screen, the method comprising the steps of:
checking whether initial key input for a predetermined direction key has lasted for more than a predetermined time period, in a state in which user interface elements are displayed on a screen;
flickering an element which is displayed on the screen and is currently in an active state, if the initial key input for the predetermined direction key is determined to have lasted for more than the predetermined time period;
checking whether key input for a direction key is performed, after flickering the element currently in the active state;
stopping flickering of the current element and finding and flickering an element closest to the current element in the direction of a direction key, if key input for the direction key is performed;
checking whether the key input for a direction key has lasted for more than a predetermined time period, after flickering the closest element;
mapping the currently flickering element to the predetermined initially input direction key and registering the currently flickering element, if the key input for the direction key is determined to have lasted for more than the predetermined time period; and
returning to the closest element finding step, if, after checking whether the key input for a direction key has been performed, the key input for a direction key is determined to have been performed, after flickering the closest element.
